(19) United States
(12) Patent Application Publication
(10) Pub. No.: US 2012/0131484 A1
(43) Pub. Date: May 24, 2012

(54) COHORT-SELECTABLE FACETED DISPLAY

(76) Inventors: Eric K. Neumann, Bedford, MA (US); Keith G. Boyce, Boston, MA (US)

(21) Appl. No.: 13/165,508

(22) Filed: Jun. 21, 2011

Related U.S. Application Data
(60) Provisional application No. 61/356,790, filed on Jun. 21, 2010.

(51) Int. Cl. G06F 3/048

(52) U.S. Cl. 715/769; 715/810

(57) ABSTRACT

A computer-implemented display of semantically characterized information can include cohort indicators representing a group of one or more specified cohort parameters applied in such a way so as to filter a dataset comprising RDF structured data items. Each cohort indicator can be associated with a set of RDF structured semantic predicates. At least one selectable facet value indicator can be included that represents one or more specified value parameters each being associated with a RDF structured semantic object. The one or more specified value parameters can be applicable to the dataset in such a way so as to enable additional filtering and modification of one or more of the resulting cohort groups of information. A visual display of filtered information can be included which results from separately applying, against the dataset, each group of one or more specified cohort parameters represented by each cohort indicator.

### RELATED APPLICATIONS

This application claims priority to, and the benefit of, co-pending U.S. Provisional Application 61/356,790, filed Jun. 21, 2010, for all subject matter common to both applications. The disclosure of said provisional application is hereby incorporated by reference in its entirety.

### FIELD OF THE INVENTION

The present invention relates to a computer-implemented display of semantically characterized information, and more particularly a display of filtered semantically characterized information by cohort indications that is updatable upon selection of facet values.

### BACKGROUND OF THE INVENTION

There are many instances where data that contains multiple attributes per record can only be displayed as whole queried sets. In other words, a user wanting to sort and filter the data must know ahead of time what is desired in terms of the parameters of the data filtering, and then create and execute a corresponding query. The query implements the desired sorting and filtering of the data and then the results can be displayed and reviewed.

To date, it has not been possible to interactively filter semantically characterized data using a faceted filtering approach. This is primarily due to the requirement of present data systems to utilize the described approach of query and then display.

Furthermore, in terms of semantically characterized data, there are additional considerations when trying to sort or filter based on cohorts. Cohorts in terms of a clinical application can loosely be defined as a group of persons sharing a particular statistical or demographic characteristic. Cohorts can be more broadly interpreted to relate to a sub-group of data records out of a larger group of data, wherein the sub-group has at least one shared or common characteristic or parameter. Users of databases presently are unable to access multiple cohort groupings of data interactively, and perform analytical and statistical updates or assessments on these groups, especially by introduction of facets and facet values. Facet values can generally be defined as selectable values for a semantic property linked directly or indirectly to a data item. A collection of facets and facet values can define a cohort (i.e., cohorts are defined as one or more facets and facet values or encoded facet parameter-value parameter pairs that filter/categorize data into a labeled group).

### SUMMARY

There is a need for an interactive display of filtered semantically characterized information by cohort indications that is updatable by interactive selection of facet values. The present invention is directed toward further solutions to address this need, in addition to having other desirable characteristics.

According to illustrative embodiments of the present invention, a computer-implemented display of semantically characterized information can include at least one cohort indicator representing a group of one or more specified cohort parameters. The group of one or more specified cohort parameters can be applied in such a way so as to filter the semantically characterized information and define a resulting cohort group of information associated with each at least one cohort indicator. At least one selectable facet value indicator can be included that represents one or more specified value parameters applicable in such a way so as to additionally filter and modify one or more of the resulting cohort groups of information. At least one visual display of filtered information can be included, which can include the resulting cohort group of information associated with each of one or more of the at least one cohort indicator. The visual display of filtered information can transform into an updated visual display of filtered information upon selection of one or more of the at least one selectable facet value indicators and application of the one or more specified value parameters to the one or more cohort groups of information.

According to further illustrative embodiments of the present invention, a plurality of cohort indicators can be included, and each of the plurality of cohort indicators can represent a group of one or more specified cohort parameters applied in such as way so as to filter the semantically characterized information and define the resulting cohort group of information. The existence of each of the plurality of cohort indicators can further filter semantically characterized information and transform the visual display of filtered information into an updated visual display of filtered information. Upon implementation of one or more of the at least one selectable facet value indicators, the one or more specified value parameters can additionally filter and modify one or more of the resulting cohort groups of information. Modification of the one or more of the resulting cohort groups of information can transform the visual display of filtered information into an updated visual display of filtered information. Implementation of one or more of the at least one selectable facet value indicators can occur by dragging and dropping one or more of the at least one selectable facet value indicators into one or more of the plurality of cohort indicators.

According to yet further illustrative embodiments of the present invention, each at least one cohort indicator can be positioned above the at least one visual display of filtered information. Each at least one selectable facet value indicator can be positioned to a side of the at least one visual display of filtered information. Each at least one selectable facet value indicator can represent a value parameter that is associated with one or more data items being displayed in the visual display of filtered information. A number count indicator associated with each value indicator can be included, and the number count indicator of any given value indicator can refer to the number of data items on the visual display of information characterized by the value parameter represented by the given value indicator. Each at least one visual display of filtered information can include one or more selected from the group consisting of a graph, a chart, a table, a plot, a timeline, a map, a histogram, a correlation, a spiderplot, a network, and a statistical summary. Each resulting one or more cohort group of information that is displayed can be assigned a different visual attribute of a plurality of visual attributes. Each of the plurality of visual attributes can be selected from the group consisting of a color, a symbol, and a shape.

According to still further illustrative embodiments of the present invention, the semantically characterized information can include RDF structured semantic data. Each value parameter can include a semantic object associated with RDF structured semantic data. One or more facet indicators can be included, which each represent a facet parameter. Each facet parameter can include a semantic property associated with RDF structured semantic data. Selection of the at least one facet value indicator can generate a SPARQL query comprising a RDF structured semantic predicate associated with the facet value indicator. The RDF structured semantic predicate associated with the at least one facet indicator can be a WHERE component of the generated SPARQL query. Each at least one cohort indicator can be associated with a set of one or more RDF structured semantic predicates.

According to other illustrative embodiments of the present invention, a computer-implemented display of semantically characterized information can include one or more cohort indicators each associated with a group of one or more specified cohort parameters that are configured to be applied as filters against a dataset comprising RDF structured data items. Each of the one or more specified cohort parameters can be associated with a user-selected RDF structured semantic predicate. For each of the one or more cohort indicators, the display can include a resultant cohort information set displayed on a visual display and resulting from applying the associated group of one or more specified cohort parameters as a filter against the dataset. A plurality of selectable facet value indicators can be included, each of which can be associated with a RDF structured semantic object that is configured to be applied as an additional filter for further filtering the resulting cohort information set of any of the one or more cohort indicators. Selection of a selectable facet value indicator can result in creation of a cohort parameter that includes the value parameter associated with the selected facet value indicator. The created cohort parameter can be added to the group of one or more specified cohort parameters associated with a selected cohort indicator. The display can be configured to enable user interactive creation, deletion, and modification of multiple cohorts.

According to yet other illustrative embodiments of the present invention, a computer-implemented display of semantically characterized information can include at least one cohort indicator representing a group of one or more specified cohort parameters applied in such a way so as to filter a dataset comprising RDF structured data items and define a resulting cohort group of information associated with each at least one cohort indicator. Each at least one cohort indicator can be associated with a set of RDF structured semantic predicates. At least one selectable facet value indicator can be included that represents one or more specified value parameters each being associated with a RDF structured semantic object. The one or more specified value parameters can be applicable to the dataset in such a way so as to enable additional filtering and modification of the resulting cohort group of information of one or more of the at least one cohort indicator. A visual display of filtered information can be included, which can include the resulting cohort group of information associated with each of one or more of the at least one cohort indicator. The visual display of filtered information can transform into an updated visual display of filtered information upon selection of one or more of the at least one selectable facet value indicators and application of the one or more value parameters associated with the one or more selected facet value indicators as filters on one or more of the at least one cohort group of information. The display can be configured to enable user-interactive creation, deletion, and modification of multiple user-defined cohorts.

### BRIEF DESCRIPTION OF THE FIGURES

These and other characteristics of the present invention will be more fully understood by reference to the following detailed description in conjunction with the attached drawings, in which:

FIG. 1 is a screen shot of a computer-implemented cohort-selectable faceted display of semantically characterized information, according to one embodiment of the present invention; and

FIG. 2 is an illustrative diagram depicting an example computing device for implementing embodiments of the present invention.

### DETAILED DESCRIPTION

An illustrative embodiment of the present invention relates to a computer-implemented display of semantically characterized information. The display includes at least one cohort indicator representing a group of one or more specified cohort parameters applied in such a way so as to filter the semantically characterized information and define a resulting cohort group of information. At least one selectable facet value indicator represents one or more specified value parameters applicable in such a way so as to additionally filter and modify one or more of the resulting cohort groups of information. A visual display shows the results of the information as filtered by the cohort parameters. The display can be interactively updated in real time upon the addition of cohort indicators and/or upon the selection of one or more of the at least one selectable facet value indicators and application of the one or more specified value parameters.

Accordingly, one of skill can appreciate that the selection of a selectable facet value indicator results in the selected facet value indicator being added as an additional cohort parameter. More specifically, selection of a facet value indicator results in an additional cohort parameter being added to one of the groups of specified cohort parameters. The additional cohort parameter comprises the value parameter represented by or associated with the selected facet value indicator. The particular group of specified cohort parameters to which the additional cohort parameter is added can be itself selected by a user. Accordingly, selection of a selectable facet value indicator can comprise both selecting a particular value parameter and selecting a particular cohort indicator. In this manner, users are enabled with real time interaction to create, delete, and modify cohorts by interacting with the cohort indicators and the facet value indicators.

The computer implemented display of semantically characterized information of the present invention is an interactive user interface that can take advantage of RDF structured (Semantic Web) data. It allows filtering and selecting data based on the choice of characteristics of and parameters by cohort and/or facet value. It also allows grouping the selections into multiple cohorts by using combinations of facet values to define and apply multi-property group (cohort) selectors. The display of the present invention enables users to drag and drop facet values into cohort boxes to construct different cohorts. Once defined, the cohorts can be re-used to view all data from the comparative perspective of these cohorts.

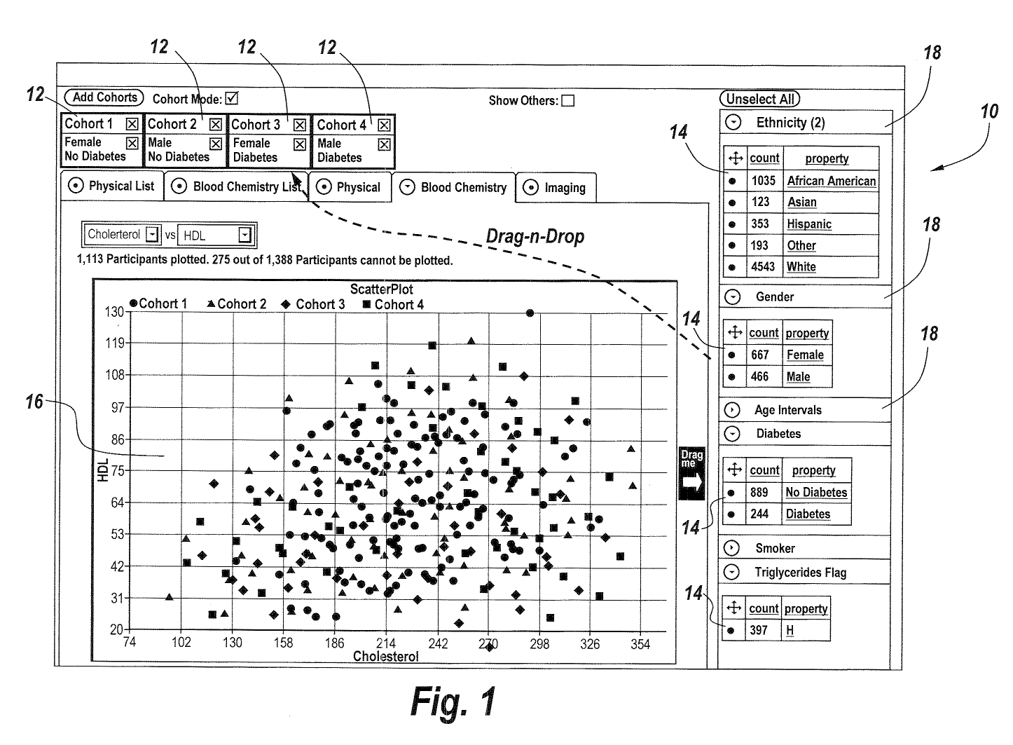

FIG. 1, wherein like parts are designated by like reference numerals throughout, illustrate an example embodiment of the computer implemented display according to the present invention. Although the present invention will be described with reference to the example embodiment illustrated in the figure, it should be understood that many alternative forms can embody the present invention. One of skill in the art will additionally appreciate different ways to alter the parameters of the embodiments disclosed in a manner still in keeping with the spirit and scope of the present invention.

As shown in FIG. 1, an example or representative layout for a screen shot or screen display generated by a computer is shown in the form of a computer implemented display 10 of semantically characterized information provides an interactive user interface that takes advantage of RDF structured (Semantic Web) data. The display 10 includes a plurality of cohort indicators 12 disposed along a top portion of the display 10. Although one of skill in the art will appreciate that the particular layout and location of each of the components of the invention as shown in the figure is merely illustrative and by no means limits the invention to the precise arrangement shown. Rather, each of the components of the present invention may be implemented in different layouts and display configurations, to the extent their functionality is preserved. Thus, the present invention is by no means limited to the layout configuration shown in the figures and discussed herein.

The display further includes a plurality of facet value indicators 14, shown in the example embodiment in a column on the right side of the display 10. Again, the layout configuration of the facet value indicators 14 is in no way limited by the example shown in the figures and described herein.

Each cohort indicator 12 represents one or more specified cohort parameters applied in such a way so as to filter the semantically characterized information and define a resulting cohort group of information. Said differently, the existence of the cohort indicator 12 on the display 10 communicates to a user that a set of one or more cohort parameters associated with or defined by the cohort indicator 12 has been applied to the dataset of semantically characterized information to filter the dataset and result in a cohort group, which is a sub-set of the dataset. If only a single cohort indicator 12 is placed on the display, then the cohort parameter(s) of that cohort indicator 12 filter the dataset and then display the resulting filtered sub-set of data on an area of the display 10, such as a visual display 16. If two or more cohort indicators 12 are placed on the display, then the cohort parameter(s) of each cohort indicators 12 separately filters the dataset and then display the resulting filtered sub-set of data on an area of the display 10, such as the visual display 16. Accordingly a user may add or remove cohort indicators 12 from the display 10, and with each addition or subtraction of a cohort indicator 12, the visual display 16 will update with a newly filtered sub-set of the dataset, as filtered by the cohort indicator(s) 12 being applied. One of skill in the art will appreciate that, when applied in this manner, the set of cohort parameter(s) associated with or represented by each cohort indicator 12 acts separately upon the dataset (i.e., is separately applied on the dataset as a filter).

Examples of cohorts in an illustrative medical application of the display 10 of the present invention include female without diabetes, male without diabetes, female with diabetes, and male with diabetes. The particular subject matter of each cohort indicator 12 will be specific to the subject matter of the dataset being filtered. The present invention is in no way limited to the particular cohort subject matter examples provided herein. Such example cohorts are provided merely for illustrative purposes.

Each selectable facet value indicator 14 represents one or more specified value parameters applicable in such a way so as to additionally filter and modify one or more of the resulting cohort groups of information. Said differently, each selectable facet value indicator 14 on the display 10 communicates to a user that a set of one or more value parameters associated with or defined by the facet value indicator 14 are available to be applied to the displayed dataset of semantically characterized information to further filter the dataset and result in a revised cohort group, which is a sub-set of the dataset. If only a single facet value indicator 14 is selected on the display, then the value parameter(s) of that facet value indicator 14 (in combination with the facet parameter(s) associated therewith) effectively filter the dataset and then display the resulting filtered sub-set of data on an area of the display 10, such as the visual display 16. If two or more facet value indicators 14 are selected, then the value parameter(s) of both facet value indicators 14 (in combination with the facet parameter(s) associated therewith) effectively filter the dataset and then display the resulting filtered sub-set of data on an area of the display 10, such as the visual display 16. Accordingly a user may add or remove facet value indicators 14 by selecting or deselecting them, and with each selection or de-selection of a facet value indicator 14, the visual display 16 will update with a newly filtered sub-set of the dataset, as filtered by the cohort indicator(s) 12 being applied and facet value indicator(s) 14 being selected.

A value or value parameter associated with a facet value indicator 14 can be defined as a selector for direct or indirect properties of a set of data items. The display additionally can include one or more facet indicators 18 indicating the particular facet or facet parameter to which a value or value parameter (or group of values or value parameters) belongs. Alternatively, a facet indicator and corresponding value indicator can be substantially included as substantially a single indicator if so desired. The present invention contemplates all such embodiments and alternatives that would be appreciated by one of skill in the art upon reading the present specification. Accordingly, “facet value indicator” herein refers to an indicator that represents a particular value, and optionally can additionally represent the particular facet or facet parameter with which the particular value is associated.

An individual facet is populated with the list of values from the current viewed data set in the visual display 16. Accordingly, every facet value indicator 14 represents a value parameter that is associated with one of the data points in the displayed data set (i.e., is associated with a data point of one of the resulting cohort groups of information). Looking again at the illustrative medical example, the patient properties: gender, ethnicity, age, smoker/non-smoker, diabetic, etc, can each be separate facets (and facet indicators 18), and the values male/female would be the values of the gender facet (and facet value indicators 14). As noted elsewhere herein, the particular subject matter of the facets, facet indicators 18, values, and value indicators 14 will correlate to the particular dataset being viewed. As such, the present invention is by no means limited to the particular facet, facet indicator, value, or value indicator subjects or topics described herein.

In the particular illustrative example of FIG. 1, the facet value indicator 14 is selected by a user clicking on the facet value indicator 1.4 and dragging it to a particular cohort indicator 12, where it is dropped into the cohort indicator 14. This action equates to selecting the facet value indicator 14 and whatever facet-value characteristics or parameters are associated therewith, and applying them against the dataset filtered by the cohort indicator 12 into which the facet value indicator 14 is dragged and dropped. It can be appreciated that in such drag-and-click embodiments, dragging and clicking a facet value indicator results in the value parameter and the facet parameter that are associated with the selected facet value indicator being added as a cohort parameter, e.g., of a particular user selected cohort. Accordingly, the cohorts can be managed, created, deleted, and modified as desired by a user via such selection mechanisms. Thus, the dataset filtered by the cohort indicator 12 is modified or revised in real-time by the interactive selection or de-selection of each facet value indicator 14.

As noted herein, the visual display 16 of filtered information transforms into an updated visual display 16 of filtered information upon selection of one or more of the at least one selectable facet value indicators 14 and application of the one or more specified facet parameters to the one or more cohort groups associated with the cohort indicators 12.

Multiple cohort indicators 12 and multiple facet value indicators 14 can be applied against a single dataset to filter the data and arrive at one or more sub-sets of data for the visual display 16.

The visual display 16 can take many different forms as desired, including but not limited to graphs, charts, tables, plots, timeline, map, histograms, correlations, spiderplots, networks, statistical summaries, and the like, to visually communicate the data and related information to a user of the display 10. As such, the present invention is by no means limited to the particular scatter chart shown in the figure.

Furthermore, multiple cohort indicators 12 each generating cohorts can be visualized together by assigning a different visual attribute, such as color, symbol, shape, or other visual indication, to the subset of data belonging to that cohort group. Likewise, additions of facet value indicators 14 and their associated facets can also be differentiated in the visual display through use of different visual indicators to aid in differentiating each facet.

The semantic nature of the data makes defining a group efficient. For example, a four cohort definition based on gender and diabetes would be defined as follows: cohort1:[#gender=female, #has_diabetes=non-diabetic], cohort2:[#gender=Male, #has_diabetes=Non-Diabetic], cohort3:[#gender=Female, #has_diabetes=Diabetic], cohort4:[#gender=Male, #has_diabetes=Diabetic]; where #gender and #has_diabetes are semantically-defined properties of patient, in accordance with the illustrative medical example. One of skill in the art can appreciate that based on this and later examples, each cohort parameter (e.g., “#gender=female”) can be configured to represent or be associated with a RDF structured semantic predicate (e.g., “gender” can represent a RDF structured semantic property and “female” can represent a RDF structured semantic object).

In accordance with aspects of the present invention, a facet configuration can be established. Facet configuration can be defined as a process where the set of facet values (and facet value indicators 14) are defined for web viewing. A semantic predicate definition of the properties can be used to define these, either as direct properties: <#gender> or as indirect properties: <#bloodtest>.<#serum_glucose>. The facet configuration can be used during application start-up to: create the view layout of the display 10 with facet subviews (e.g., each subview being based on a particular facet/RDF structured semantic property); collect all the values for each property (and their counts) in the data set; add each value (with counts) to an appropriate list or subview within a facet generation; and/or display the subviews, collected values, and/or collected counts. Facet selection is translated by the user interface (UI) and server application to build SPARQL queries.

An illustrative example implementation of the present invention can be implemented as follows:

The RDF structure enables the definition of simple and composed
properties for a facet configuration, such as in the following configuration
example:
<entry key=“label” value=“Gender”>
<entry key=“property”>

<value>![CDATA[ <#gender> ]]></value>

</entry>
will translate into the following SPARQL call when a value is clicked on
for this facet: SELECT *
WHERE {

?subj1 :gender ?gender_obj .
FILTER ?gender_obj = SELECTED_VALUE

}
For more complex composite facet relations:
<entry key=“label” value=“Serum Glucose”>
<entry key=“property”>

<value>![CDATA[ <#bloodtest>.<#serum_glucose> ]]></value>

</entry>
will translate into the following SPARQL call when a value is clicked on
for this facet: SELECT *
WHERE {

?subj1 :bloodtest ?bloodtest_obj .
?bloodtest_obj :serum_glucose ?serum_glucose_obj .
FILTER ?serum_glucose_obj = SELECTED_VALUE

}
Dragging-and-dropping a facet value is done by tagging the following
RDF fragment (predicate) to the drag object, which when released is
stored into one of the assigned cohort sets:
DRAG-PREDICATE-OBJ [ :gender “Male” ]
A cohort box can contain the following predicate sets:
COHORT-1 [

PREDICATE-OBJ [ :gender “Male” ]
PREDICATE-OBJ [ :has_diabetes “Diabetic” ]
PREDICATE-OBJ [ :cardiovascular_incident “NONE” ]

The facets are defined by encoding the desired facets and their
arrangement (along with data views) into a XML configuration code.
Example of facet configuration code:
<entry key=″facet1″>

<map>

<entry key=″label″ value=″Disease″/>
<entry key=″property″>

<value><![CDATA[<#for_indication>.<rdfs#label>]]></value>

</entry>
<entry key=″expanded″>

<value type=″java.lang.Boolean″>true</value>

</entry>

</map>

</entry>

Accordingly, one of skill can appreciate that each cohort parameter can represent or being associated with a RDF structured semantic predicate (i.e., a property-object pair). The present invention may be implemented on a computer as such term has been generally defined in the art. Computers include some form of processor, input, and output. The output can include a form of monitor or other screen display, upon which the display 10 of the present invention may be produced. For example, in illustrative embodiments of the present invention, the display 10 is included in an online website accessible via the internet or other network connection. As one of skill in the art would appreciate, the online website can be presented to a user, for example, on a monitor or other screen display operated by the user (e.g., within a web browser application on a user's personal computer).

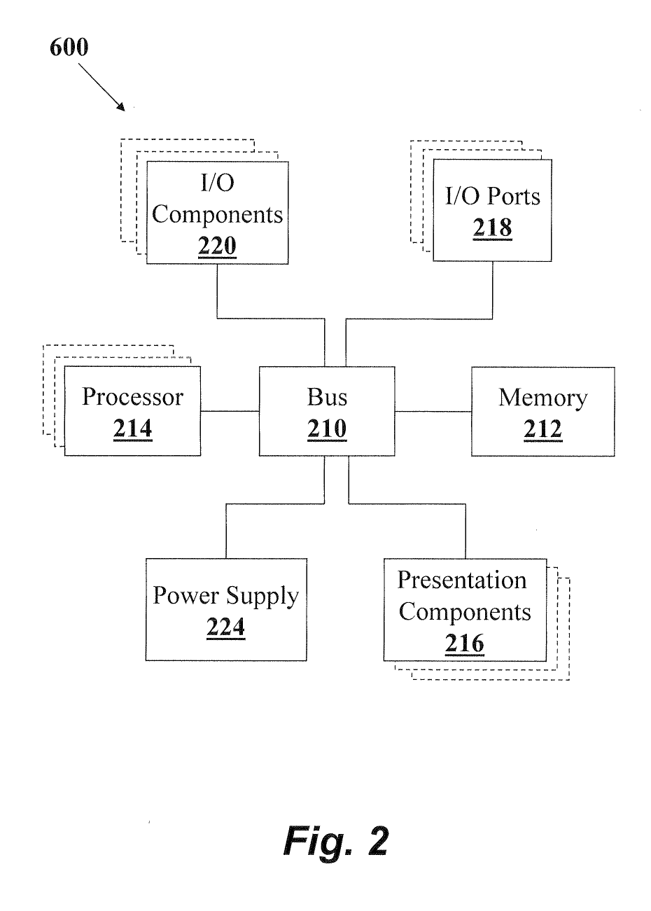

As would be appreciated by one of skill in the art, FIG. 2 illustrates an example computing device 600 within an illustrative operating environment for implementing illustrative methods and systems of the present invention. The computing device 600 is merely an illustrative example of a suitable computing environment and in no way limits the scope of the present invention. A “computing device,” as represented by FIG. 2, can include a “workstation,” a “server,” a “laptop,” a “desktop,” a “hand-held device,” a “mobile device,” a “tablet computer,” or other computing devices, as would be understood by those of skill in the art. Given that the computing device 600 is depicted for illustrative purposes, embodiments of the present invention may utilize any number of computing devices 600 in any number of different ways in order to implement a single embodiment of the present invention. Accordingly, embodiments of the present invention are not limited to a single computing device 600, as would be appreciated by one with skill in the art, nor are they limited to a single type of implementation or configuration of the example computing device 600.

The computing device 600 can include a bus 610 that can be coupled to one or more of the following illustrative components, directly or indirectly: a memory 612, one or more processors 614, one or more presentation components 616, input/output ports 618, input/output components 620, and a power supply 624. One of skill in the art will appreciate that the bus 610 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 2 is merely illustrative of an exemplary computing device that can be used to implement one or more embodiments of the present invention, and in no way limits the invention.

The computing device 600 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 200.

The memory 612 can include computer-storage media in the form of volatile and/or nonvolatile memory. The memory 612 may be removable, non-removable, or any combination thereof. Exemplary hardware devices are devices such as hard drives, solid-state memory, optical-disc drives, and the like. The computing device 600 can include one or more processors that read data from components such as the memory 612, the various I/O components 616, etc. Presentation component(s) 616 present data indications to a user or other device. Exemplary presentation components include a display device, speaker, printing component, vibrating component, etc.

The I/O ports 618 can allow the computing device 600 to be logically coupled to other devices, such as I/O components 620. Some of the I/O components 620 can be built into the computing device 600. Examples of such I/O components 620 include a microphone, joystick, recording device, game pad, satellite dish, scanner, printer, wireless device, networking device, and the like. For example, the I/O components 620 can include one or more networking devices that enable the computing device 600 to connect to the internet, in order to enable the display 10 to be included in an online website that is accessible to users via an internee connection from a personal computer, etc.

Given that computers are generally known to those of skill in the art, further detail concerning particular hardware implementations and software implementations will not be discussed further herein.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computer-implemented display of semantically characterized information, comprising:
at least one cohort indicator representing a group of one or more specified cohort parameters, the group of one or more specified cohort parameters being applied in such a way so as to filter the semantically characterized information and define a resulting cohort group of information associated with each at least one cohort indicator;
at least one selectable facet value indicator representing one or more specified value parameters applicable in such a way so as to additionally filter and modify one or more of the resulting cohort groups of information;
at least one visual display of filtered information that includes the resulting cohort group of information associated with each of one or more of the at least one cohort indicator;
wherein the visual display of filtered information transforms into an updated visual display of filtered information upon selection of one or more of the at least one selectable facet value indicators and application of the one or more specified value parameters to the one or more cohort groups of information.

2. The display of claim 1, comprising a plurality of cohort indicators, each of the plurality of cohort indicators representing a group of one or more specified cohort parameters applied in such as way so as to filter the semantically characterized information and define the resulting cohort group of information, wherein existence of each of the plurality of cohort indicators further filters semantically characterized information and transforms the visual display of filtered information into an updated visual display of filtered information.

3. The display of claim 1, wherein upon implementation of one or more of the at least one selectable facet value indicators, the one or more specified value parameters additionally filters and modifies one or more of the resulting cohort groups of information.

4. The display of claim 3, wherein modification of the one or more of the resulting cohort groups of information transforms the visual display of filtered information into an updated visual display of filtered information.

5. The display of claim 3, wherein implementation of one or more of the at least one selectable facet value indicators occurs by dragging and dropping one or more of the at least one selectable facet value indicators into one or more of the plurality of cohort indicators.

6. The display of claim 1, wherein each at least one cohort indicator is positioned above the at least one visual display of filtered information and further wherein each at least one selectable facet value indicator is positioned to a side of the at least one visual display of filtered information.

7. The display of claim 1, wherein each at least one selectable facet value indicator represents a value parameter that is associated with one or more data items being displayed in the visual display of filtered information.

8. The display of claim 1, further comprising a number count indicator associated with each value indicator, wherein the number count indicator of any given value indicator refers to the number of data items on the visual display of information characterized by the value parameter represented by the given value indicator.

9. The display of claim 1, wherein each at least one visual display of filtered information comprises one or more selected from the group consisting of a graph, a chart, a table, a plot, a timeline, a map, a histogram, a correlation, a spiderplot, a network, and a statistical summary.

10. The display of claim 1, wherein each resulting one or more cohort group of information that is displayed is assigned a different visual attribute of a plurality of visual attributes.

11. The display of claim 10, wherein each of the plurality of visual attributes is selected from the group consisting of a color, a symbol, and a shape.

12. The display of claim 1, wherein the semantically characterized information comprises RDF structured semantic data.

13. The display of claim 1, wherein each value parameter comprises a semantic object associated with RDF structured semantic data.

14. The display of claim 1, further comprising one or more facet indicators each representing a facet parameter.

15. The display of claim 14, wherein each facet parameter comprises a semantic property associated with RDF structured semantic data.

16. The display of claim 1, wherein selection of the at least one facet value indicator generates a SPARQL query comprising a RDF structured semantic predicate associated with the facet value indicator.

17. The display of claim 16, further wherein the RDF structured semantic predicate associated with the at least one facet indicator is a WHERE component of the generated SPARQL query.

18. The display of claim 1, wherein each at least one cohort indicator is associated with a set of one or more RDF structured semantic predicates.

19. A computer-implemented display of semantically characterized information, comprising:
one or more cohort indicators each associated with a group of one or more specified cohort parameters that are configured to be applied as filters against a dataset comprising RDF structured data items, each of the one or more specified cohort parameters being associated with a user-selected RDF structured semantic predicate;
for each of the one or more cohort indicators, a resultant cohort information set displayed on a visual display and resulting from applying the associated group of one or more specified cohort parameters as a filter against the dataset; and
a plurality of selectable facet value indicators each being associated with a RDF structured semantic object that is configured to be applied as an additional filter for further filtering the resulting cohort information set of any of the one or more cohort indicators;
wherein selection of a selectable facet value indicator results in creation of a cohort parameter comprising the value parameter associated with the selected facet value indicator, the created cohort parameter being added to the group of one or more specified cohort parameters associated with a selected cohort indicator; and
wherein the display is configured to enable user interactive creation, deletion, and modification of multiple cohorts.

20. A computer-implemented display of semantically characterized information, comprising:
at least one cohort indicator representing a group of one or more specified cohort parameters applied in such a way so as to filter a dataset comprising RDF structured data items and define a resulting cohort group of information associated with each at least one cohort indicator, each at least one cohort indicator being associated with a set of RDF structured semantic predicates;
at least one selectable facet value indicator representing one or more specified value parameters each being associated with a RDF structured semantic object, the one or more specified value parameters being applicable to the dataset in such a way so as to enable additional filtering and modification of the resulting cohort group of information of one or more of the at least one cohort indicator; and
a visual display of filtered information that includes the resulting cohort group of information associated with each of one or more of the at least one cohort indicator;
wherein the visual display of filtered information transforms into an updated visual display of filtered information upon selection of one or more of the at least one selectable facet value indicators and application of the one or more value parameters associated with the one or more selected facet value indicators as filters on one or more of the at least one cohort group of information; and
wherein the display is configured to enable user-interactive creation, deletion, and modification of multiple user-defined cohorts.
